(19) United States
(12) Patent Application Publication
(10) Pub. No.: US 2025/0062357 A1
(43) Pub. Date: Feb. 20, 2025

(54) SELF-STANDING FILM FOR ANODE OF LITHIUM SECONDARY BATTERY, AND METHOD FOR MANUFACTURING THE SAME

(71) Applicants: Hyundai Motor Company, Seoul (KR); Kia Corporation, Seoul (KR)

(72) Inventors: Ju Young Jang, Goyang (KR); Dong Hyeop Han, Seoul (KR); Byung Yong Lee, Anyang (KR); Hyun Jeong Kim, Suwon (KR)

(21) Appl. No.: 18/510,987

(22) Filed: Nov. 16, 2023

(30) Foreign Application Priority Data
Aug. 14, 2023 (KR) 10-2023-0106487

(51) Int. Cl. H01M 4/62; H01M 4/04; H01M 4/139; H01M 4/66; H01M 10/052

(52) U.S. Cl. CPC H01M 4/623; H01M 4/0435; H01M 4/139; H01M 4/663; H01M 4/667; H01M 10/052; H01M 2004/021; H01M 2004/027; H01M 2220/20

(57) ABSTRACT

A self-standing film for an anode of a lithium secondary battery, the self-standing film including an anode active material, a conductive material, a first binder containing a triblock copolymer, and a second binder containing a fluorine-based resin, wherein the triblock copolymer includes a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder is in the form of a non-continuous column connecting between any one of a domain of the anode active material or a domain of the conductive material and another one of a domain of the anode active material or a domain of the conductive material.

### CROSS-REFERENCE TO RELATED APPLICATIONS

This application claims the priority of Korean Patent Application No. 10-2023-0106487 filed on Aug. 14, 2023, in the Korean Intellectual Property Office, the disclosure of which is incorporated herein by reference.

### BACKGROUND

### Field

In one aspect, the present disclosure relates to a self-standing film for an anode of a lithium secondary battery, using a blend of a first binder including a triblock copolymer containing a soft block and a hard block and a second binder including a fluorine-based resin, and a method for manufacturing the same.

### Background

Lithium secondary batteries, since their first commercialization in the 1990s, have been widely applied in the portable electronics market, and have been subjected to continuous interest as the most researched energy storage systems. As lithium secondary batteries provided with features such as high driving voltage, high energy density, low self-discharge rate, high rate performance, and long cycle stability, the lithium secondary batteries satisfy conditions required to be suitable as an energy source for electric vehicles.

Still, the lithium secondary batteries applied to electric vehicles are left with three major issues: safety, service time, and costs. The issues of safety and service time may be resolved using solid-state batteries, and yet the issue of costs contributes to hindering the extensive application of lithium secondary batteries, and thus a great deal of research is underway to reduce the costs of lithium secondary batteries.

Reducing energy consumption required for manufacturing or increasing electrode thickness is one of the most effective ways to reduce the manufacturing costs of lithium secondary batteries. In typical methods for manufacturing an electrode, a current collector is cast with a slurry in which an electrode active material, a polymer binder, and a conductive additive are mixed in water or an organic solvent and the resulting product is dried and pressed to form an electrode, but in this way, the energy required to manufacture the slurry and coat the current collector takes up about 50% of the energy consumed over the entire manufacturing process, and thus research has been done into a process for manufacturing dry electrodes without solvents to reduce the manufacturing costs of lithium secondary batteries.

Despite the fact that much research has been conducted on the methods for manufacturing dry electrodes, the development of dry electrodes having mechanical properties and flexibility suitable for mass production using roll press equipment and the like has not been successful yet, and this requires further research and development.

### SUMMARY

An aspect of the present disclosure provides a self-standing film for an anode of a lithium secondary battery, which may obtain excellent mechanical properties and flexibility, and a method for manufacturing the same.

In one aspect, a self-standing film suitable for an anode of a lithium secondary battery is provided, the self-standing film comprising: a) an anode active material; b) a conductive material; c) a first binder comprising a triblock copolymer; and d) a second binder comprising a fluorine-based resin, wherein the triblock copolymer comprises a soft block derived from aliphatic or cycloaliphatic diene-based monomers and exhibiting a rubber phase at room temperature, and a first hard block and a second hard block each connected to ends of the soft block, derived from an aromatic ring-containing ethylenically unsaturated monomer, and exhibiting a glass phase at room temperature, and the first binder comprises any one of a) a domain of the anode active material or b) a domain of the conductive material and i) another one of a domain of the anode active material or ii) a domain of the conductive material.

In a further aspect, there is provided a self-standing film for an anode of a lithium secondary battery, which includes an anode active material, a conductive material, a first binder including a triblock copolymer, and a second binder including a fluorine-based resin. In this case, the triblock copolymer may include a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder may be in the form of a non-continuous column connecting between any one of a domain of the anode active material or a domain of the conductive material and another one of a domain of the anode active material or a domain of the conductive material. In another aspect, a method for manufacturing a self-standing film suitable for an anode of a lithium secondary battery is provided, the method comprising: a) forming an anode active material layer through a film fabrication process using a composition for forming an anode of a lithium secondary battery, the composition comprising: i) an anode active material; a conductive material; a first binder comprising a triblock copolymer particles having an average diameter (D₅₀) of 1 μm to 50 μm; and ii) a second binder comprising a fluorine-based resin, wherein the triblock copolymer comprises a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature.

According to another aspect of the present disclosure, there is provided a method for manufacturing a self-standing film laminate for an anode of a lithium secondary battery, wherein the method includes forming an anode active material layer through a film fabrication process using a composition for forming an anode of a lithium secondary battery, and the composition includes an anode active material, a conductive material, a first binder including a triblock copolymer, and a second binder including a fluorine-based resin. In this case, the triblock copolymer may include a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder in the composition for forming an anode of a lithium secondary battery may include triblock copolymer particles having an average diameter (DSO) of 1 μm to 50 μm.

In aspects, in a self-standing film as disclosed herein, suitably the domain of the anode active material or the domain of the conductive material and the first binder which is in the form of a non-continuous column are connected to form a three-dimensional network structure.

In aspects, in a self-standing film as disclosed herein, suitably the second binder is in a fibrous form that binds the anode active material and the conductive material.

In aspects, in a self-standing film as disclosed herein, suitably the anode active material and the conductive material bounded by the second binder are connected by the first binder in the form of a column.

In aspects, in a self-standing film as disclosed herein, suitably the first binder and the second binder are at a mass ratio of 1:3 to 0.3.

In aspects, in a self-standing film as disclosed herein, suitably the first binder has an average width perpendicular to a longitudinal direction of 0.1 μm to 2 μm.

In aspects, in a self-standing film as disclosed herein, suitably a first glass transition temperature and a second glass transition temperature each corresponding to the first hard block and the second hard block are independently 50° C. to 120° C., and a third glass transition temperature corresponding to the soft block is −120° C. to −50° C.

In aspects, in a self-standing film as disclosed herein, suitably the soft block is derived from an aliphatic diene-based monomer comprising at least one selected from the group consisting of a butadiene-based monomer, a pentadiene-based monomer, and a hexadiene-based monomer.

In aspects, in a self-standing film as disclosed herein, suitably the first hard block and the second hard block are each independently derived from an aromatic ring-containing ethylenically unsaturated monomer comprising at least one of a styrene-based monomer and an aromatic (meth)acryl-based monomer.

In an aspect, provided is a negative electrode of a lithium secondary battery that includes the composition as described herein.

In an aspect, provided is a lithium secondary battery including the negative electrode as described herein.

In an aspect, provided is a vehicle including the lithium secondary battery as described herein.

The term “self-standing film or sheet” or other similar term as used herein refers to a sheet in the form that can be handled as an independent sheet without with assistance of a substrate or support. Thus, the term “self-standing” may have the same meaning as “self-supporting”.

A term “all-solid-state battery” as used herein includes or refers to a rechargeable battery (including a secondary battery) that includes an electrolyte in a solid state, e.g., gel or polymer (cured), which may include an ionomer and other electrolytic components for transferring ions between the electrodes of the battery. In certain aspect, a lithium secondary battery as referred to herein is an all-solid state battery.

As referred to herein, a rubber phase or state is above the T_{g}, (glass transition temperature) of the material, i.e. where the material may be in a more rubber state, and comparatively soft and flexible. Thus, when stated herein that the material forms a forming a rubbery phase at room temperature (e.g. 25° C.), the material may be above its glass transition temperature at room temperature (25° C.) and may in a comparatively rubbery or more flexible state.

As referred to herein, a glass phase or state is below the T_{g}, (glass transition temperature) of the material, and where the material may be in a more rigid or glassy configuration. Thus, when stated herein that the material forms a glass phase at room temperature (e.g. 25° C.), the material may be below its glass transition temperature at room temperature (25° C.) and may in a comparatively rigid or hardened state.

A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery. In certain aspect, a lithium secondary battery as referred to herein is an all-solid state battery.

As referred to herein the term “block polymer” includes a polymer comprising two or more chemically distinct regions or segments (referred to as “blocks”) typically joined in a linear manner, e.g. a polymer comprising chemically differentiated units which are joined (covalently bonded) end-to-end with respect to polymerized functionality, rather than in pendent or grafted fashion. In one aspect, a block polymer may comprise (i) a first polymer block comprising at least 5, 10, 20 or 30 first repeating units; and (ii) a second polymer block comprising at least 5, 10, 20 or 30 second repeating units.

As referred to herein, the terms “soft block” and “hard block” indicate that the respective polymer units or portions differ in e.g. in structure and one or more properties. In certain aspects, the soft block may have a lower glass transition temperature or melting temperature (e.g. below room temperature) than a hard block (which may have a glass transition temperature or melting temperature higher (such as above room temperature) than the application temperature of the formed block copolymer material. In certain embodiments, the Tg of hard and soft blocks may differ by e.g. up to or more than e.g. 3° C., 5° C., 10° C., 20° C. or 30° C.

Other aspects are disclosed infra.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is an SEM image of a self-standing film according to Example 2;

FIG. 1B is a view showing a network structure formed in the self-standing film according to Example 2;

FIG. 2A is an SEM image of a composition (mixed powder) for forming a self-standing film before manufacturing the self-standing film of Example 2;

FIG. 2B is an SEM image of SBS powder before manufacturing the mixed powder shown in FIG. 2A;

FIG. 3A is an image taken after evaluating flexibility of the self-standing film of Example 2 according to Experimental Example 5;

FIG. 3B is an image taken after evaluating flexibility of a self-standing film of Comparative Example 1 according to Experimental Example 5; and

FIG. 3C is an image taken after evaluating flexibility of a self-standing film of Reference Example 1 according to Experimental Example 5.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

Hereinafter, a self-standing film for an anode of a lithium secondary battery and a method for manufacturing the same will be described in detail so that the present disclosure may be easily carried out by a person skill in the art to which the present disclosure pertains.

### Self-Standing Film for Anode of Lithium Secondary Battery

A self-standing film for an anode of a lithium secondary battery of the present disclosure is a self-standing anode active material layer including an anode active material, a conductive material, a first binder, and a second binder.

The first binder may include a triblock copolymer. In this case, the triblock copolymer may include a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature, and the first binder including the triblock copolymer may be in the form of a non-continuous column connecting between any one of a domain of the anode active material or a domain of the conductive material and another one of a domain of the anode active material or a domain of the conductive material.

The soft block may contain repeating units derived from aliphatic diene-based monomers and/or cycloaliphatic diene-based monomers and exhibit a rubber phase at room temperature, and specifically may be derived from the aliphatic diene-based monomers containing at least one selected from the group consisting of a butadiene-based monomer, a pentadiene-based monomer, and a hexadiene-based monomer.

The butadiene-based monomer may include at least one selected from the group consisting of 1,2-butadiene, 1,3-butadiene, isoprene, and chloroprene.

The pentadiene-based monomer may include at least one selected from the group consisting of 1,2-pentadiene, 1,3-pentadiene, 1,4-pentadiene, 2,3-pentadiene, 2-methyl-1,3-pentadiene, 2-methyl-1,4-pentadiene, 2-methyl-2,3-pentadiene, 2-methyl-2,4-pentadiene, 3-methyl-1,3-pentadiene, 3-methyl-1,4-pentadiene, 4-methyl-1,3-pentadiene, 2-ethyl-1,3-pentadiene, 2-ethyl-1,4-pentadiene, 2-ethyl-2,4-pentadiene, 3-ethyl-1,3-pentadiene, 3-ethyl-1,4-pentadiene, 4-ethyl-1,3-pentadiene, 1-chloro-1,3-pentadiene, 1-chloro-2,4-pentadiene, 2-chloro-1,3-pentadiene, 3-chloro-1,3-pentadiene, 3-chloro-1,4-pentadiene, and 5-chloro-1,3-pentadiene.

The hexadiene-based monomer may include at least one selected from the group consisting of 1,2-hexadiene, 1,3-hexadiene, 1,4-hexadiene, 1,5-hexadiene, 2,3-hexadiene, 2,4-hexadiene, 2,5-hexadiene, 3,5-hexadiene, 2-methyl-1,3-hexadiene, 2-methyl-1,4-hexadiene, 2-methyl-1,5-hexadiene, 2-methyl-2,3-hexadiene, 2-methyl-2,4-hexadiene, 3-methyl-1,2-hexadiene, 3-methyl-1,3-hexadiene, 3-methyl-1,4-hexadiene, 3-methyl-1, 5-hexadiene, 3-methyl-2,4-hexadiene, 3-methyl-2,5-hexadiene, 4-methyl-1,3-hexadiene, 4-methyl-1,4-hexadiene, 4-methyl-2,3-hexadiene, 5-methyl-1,3-hexadiene, 5-methyl-1,4-hexadiene, 2-ethyl-1,3-hexadiene, 2-ethyl-1,4-hexadiene, 3-ethyl-1,2-hexadiene, 3-ethyl-1,3-hexadiene, 3-ethyl-1,4-hexadiene, and 3-ethyl-1,5-hexadiene.

The soft block may serve to provide flexibility to the triblock copolymer and to improve extrusion molding properties and wear resistance.

The first hard block and the second hard block may include a repeating unit derived from an ethylenically unsaturated monomer containing an aromatic ring and exhibit a glass phase at room temperature, and specifically, the aromatic ring contained in the ethylenically unsaturated monomer may be a substituted or unsubstituted benzene ring or a substituted or unsubstituted naphthalene ring.

In addition, the aromatic ring may be connected to a main chain or a side chain of the repeating units of the first hard block and the second hard block, and may preferably be connected to a side chain of the repeating units of the first hard block and the second hard block.

The first hard block and the second hard block may each independently be derived from an aromatic ring-containing ethylenically unsaturated monomer including at least one of a styrene-based monomer and an aromatic (meth)acryl-based monomer.

The styrene-based monomer may include at least one selected from the group consisting of styrene, α-methylstyrene, p-methylstyrene, p-methoxystyrene, p-ethoxystyrene, t-butoxystyrene, p-acetoxystyrene, p-chlorostyrene, p-bromostyrene, 2,4-dimethylstyrene, 3,5-dimethylstyrene, and 2,4,6-trimethylstyrene.

The aromatic (meth)acryl-based monomer may include at least one selected from the group consisting of benzyl acrylate, benzyl methacrylate, phenoxyacrylate, phenoxymethacrylate, phenyl acrylate, phenyl methacrylate, phenylethyl acrylate, and phenylethyl methacrylate.

The first hard block and the second hard block may be strongly bonded to the anode active material or the conductive material through pi-pi interactions resulting from to the aromatic ring structure included in the repeating units. In addition, the first hard block and the second hard block may provide high strength properties to the triblock copolymer including the first hard block and the second hard block.

In this case, the soft block, the first hard block, and the second hard block included in the triblock copolymer may exhibit independent properties without affecting each other, and accordingly, the soft block may provide appropriate flexibility, and the first hard block and the second hard block may each provide a strong bonding strength with the anode active material or the conductive material to the self-standing film for an anode of a lithium secondary battery.

In an embodiment, any one of a domain of the anode active material or a domain of the conductive material and another one of a domain of the anode active material or a domain of the conductive material may be connected by the first binder in the form of a non-continuous column (or wire) to form a three-dimensional network structure. That is, any one surface of the anode active material or the conductive material and the other surface of the anode active material or the conductive material may be connected by a binder in the form of a non-continuous column (or wire) to form a complex having a three-dimensional network structure in a net shape (the active materials or the conductive materials are located at the intersections, and a linear binder connects the materials).

Such a three-dimensional network structure may result from the strong pi-pi interactions between the first hard block and the second hard block included in the triblock copolymer and the anode active material or the conductive material. In this case, the domain of the anode active material or the domain of the conductive material and the first binder which is in the form of a non-continuous column may be connected to form a three-dimensional network structure, thereby improving tensile strength.

In an embodiment, the first binder may have an average width perpendicular to a longitudinal direction of 0.1 μm to 2 μm, preferably 0.2 μm to 0.8 μm, and more preferably 0.3 μm to 0.7 μm. In this case, an average width perpendicular to a longitudinal direction with respect to the first binder in the form of column included in the self-standing film for an anode of a lithium secondary battery is a value obtained by measuring a width perpendicular to a longitudinal direction at both ends and at the center along the longitudinal direction with respect to the first binder of five columns selected at random, and taking the average of these measured values, using an image of the first binder particles observed with a scanning electron microscope (SEM).

In an embodiment, the first glass transition temperature and the second glass transition temperature each corresponding to the first hard block and the second hard block may be 50° C. to 120° C., and the third glass transition temperature corresponding to the soft block may be −120° C. to −50° C. Preferably, the first glass transition temperature and the second glass transition temperature may be 80° C. to 120° C. and the third glass transition temperature may be −120° C. to −80° C., more preferably, the first glass transition temperature and the second glass transition temperature may be 80° C. to 110° C. and the third glass transition temperature may be −110° C. to −80° C. As such, the first hard block, the second hard block, and the soft block included in the triblock copolymer have a glass transition temperature in the numerical ranges described above, and accordingly, the self-standing film for an anode of a lithium secondary battery including the first binder containing the triblock copolymer may have further improved durability and flexibility and may further maintain the shape more effectively.

In an embodiment, the first hard block and the second hard block may be in an amount of 10 wt % to 60 wt %, preferably 15 wt % to 55 wt %, more preferably 20 wt % to 50 wt %, with respect to the total amount of the triblock copolymer. When the amount of the first hard block and the second hard block satisfies the numerical range described above, the bonding strength may be further improved due to strong interactions with the negative active material or the conductive material, and the triblock copolymer may have appropriate flexibility to be equipped with much superior molding properties.

In an embodiment, the first hard block and the second hard block may each have a weight average molecular weight of 9,000 g/mol to 20,000 g/mol, preferably 9,500 g/mol to 20,000 g/mol, more preferably 10,000 g/mol to 20,000 g/mol. When the weight average molecular weight of each of the first hard block and the second hard block satisfies the numerical range described above, the physical crosslinking power between the first binder and the anode active material or the conductive material may be improved to form a more stable three-dimensional network structure, and deformation may be easy in manufacturing electrodes to further improve processability.

The second binder may include a fluorine-based resin. The fluorine-based resin may be in a fibrous form and may serve as a matrix that supports the anode active material and the conductive material and binds the anode active material and the conductive material together. To be specific, the anode active material and/or the conductive material may be wound and bound by the fluorine-based resin having a fibrous form, and in the case, the anode active material and/or the conductive material bonded and fixed by the fluorine-based resin may partially or entirely be connected by the first binder in the form of a column.

In addition, the fluorine-based resin having a fibrous form may have a greater average length and a smaller average width perpendicular to the longitudinal direction than the first binder in the form of a column, and accordingly, the fluorine-based resin may have significantly outstanding flexibility.

The fluorine-based resin may include, for example, at least one selected from the group consisting of polyvinylidene fluoride (PVDF), polyvinylidene fluoride-hexafluoropropylene (PVDF-HFP), polyvinylidene fluoride-trifluoroethylene (PVDF-TrFE), polyvinylidene fluoride-tetrafluoroethylene (PVDF-TFE), polyvinylidene fluoride-chlorofluoroethylene (PVDF-CTFE), and polytetrafluoroethylene (PTFE).

The type of the anode active material is not particularly limited, and various types of known anode active materials may be used. For example, the anode active material may include at least one selected from the group consisting of a carbon-based active material, a silicon-based active material, a metal-based active material that may be alloyed with lithium, and a lithium-containing active material.

The carbon-based active material may be, for example, graphite, hard carbon, soft carbon, or graphene. The graphite may be artificial graphite, natural graphite, a mixture of artificial graphite and natural graphite, natural graphite coated with artificial graphite, or a combination thereof.

The carbon-based active material has a little change in crystal structure in the process of intercalation and deintercalation of lithium ions, and may thus allow continuous and repeated redox reactions at an electrode to obtain a lithium secondary battery having high capacity and greater lifespan.

The silicon-based active material may be, for example, Si, SiOₘ, Si—C composite, Si-Q alloy, or a combination thereof, m satisfies 0<m≤2, Q may be an alkali metal, an alkaline earth metal, Group 13 to Group 16 elements, a transition metal, a rare earth element, or a combination thereof, and Si is excluded from Q.

The metal-based active materials that may be alloyed with lithium may be, for example, B, Al, Ga, In, Ge, Sn, Pb, P, As, Sb, Bi, Mg, Ca, Zn, Cd, Pd, Ag, Au, Pt, an alloy thereof, or an oxide thereof.

The lithium-containing active material may be, for example, lithium-containing titanium complex oxide (LTO).

The type of the conductive material is not particularly limited, and various types of known conductive materials may be used. For example, the conductive material may include at least one selected from the group consisting of graphite, active carbon, carbon black, acetylene black, Ketjen black, carbon nanotubes, graphene, and carbon fiber.

The self-standing film for an anode of a lithium secondary battery is a self-standing anode active material layer and may have the form of a thin film or a film that maintains a certain form on its own without being supported by other materials. In this case, the first binder and the second binder may serve to connect the anode active material and/or the binder in the self-standing film for an anode of a lithium secondary battery to maintain the form of the self-standing film for an anode of a lithium secondary battery.

As described above, the self-standing film for an anode of a lithium secondary battery includes the first binder containing the triblock copolymer and the second binder containing the fluorine-based resin, and may thus have excellent mechanical properties derived from the first hard block and the second hard block of the triblock copolymer and excellent flexibility derived from the fibrous fluorine-based resin.

In an embodiment, the first binder and the second binder are at a mass ratio of 1:3 to 0.3, 1:3 to 0.6, 1:3 to 0.75, 1:3 to 0.9, 1:2.5 to 0.9, 1:2 to 0.9, 1:1.75 to 0.9, 1:1.5 to 0.9, or 1:1.3 to 0.9, and in this case, the self-standing film for an anode of a lithium secondary battery may have excellent mechanical properties and excellent flexibility, and may also have excellent adhesion to a current collector and relatively low sheet resistance.

In this case, the excellent adhesion to a current collector may be attributed to pi-pi interactions between the aromatic ring structure included in the repeating units of the first hard block and the second hard block in the first binder, and the current collector, and the relatively low sheet resistance may be attributed to the fact that the first binder having greater polarity than the second binder contributes to lowering the sheet resistance of the self-standing film for an anode of a lithium secondary battery. As such, the excellent properties derived from each of the first binder and the second binder are maximized when the mass ratio of the first binder and the second binder satisfies the numerical ranges described above, and this is presumed to be because the first binder and the second binder form an optimal network structure when the numerical ranges described above are satisfied.

### Anode for Lithium Secondary Battery

An anode for the lithium secondary battery of the present disclosure includes the self-standing film for an anode of a lithium secondary battery described above, and a current collector.

The current collector is not particularly limited as long as the current collector is highly conductive without causing chemical changes in the anode. For example, stainless steel, aluminum, nickel, titanium, fired carbon, copper, an alloy thereof, or stainless steel that is surface-treated with one of carbon, nickel, titanium, silver, or the like may be used as the current collector.

As described above, the triblock copolymer in the first binder included in the self-standing film for an anode of a lithium secondary battery may have excellent adhesion to the current collector through pi-pi interactions resulting from the aromatic ring structure included in the repeating units of the first hard block and the second hard block, and the self-standing film for an anode of a lithium secondary battery may thus have excellent adhesion to the current collector.

In an embodiment, in the current collector, a primer layer containing a carbon-based material may be formed on a surface of a side where the self-standing film for an anode of the lithium secondary battery is disposed. The carbon-based material may include, for example, at least one selected from the group consisting of graphite, graphene, carbon black, denka black, acetylene black, Ketjen black, channel black, furnace black, lamp black, thermal black, carbon nanotubes, graphite fiber, and carbon fiber.

The carbon-based material included in the primer layer may have excellent adhesion to the self-standing film for an anode of a lithium secondary battery through pi-pi interactions with the aromatic ring structure included in the repeating units of the first hard block and the second hard block. Accordingly, when the primer layer is formed, adhesion between the self-standing film laminate for an anode of the lithium secondary battery and the current collector may be further improved.

### Lithium Secondary Battery

A lithium secondary battery of the present disclosure may include the anode for a lithium secondary battery above-described, a cathode for a lithium secondary battery, and an electrolyte.

The cathode for a lithium secondary battery may include at least one cathode active material selected from the group consisting of lithium, nickel, cobalt, manganese, iron, tin, silicon, aluminum, and a mixture thereof. For example, as for the cathode for a lithium secondary battery, cathode active materials such as LiCoO₂, LiMnO₂, LiFeO₂, Li (Ni_{0.6}Mn_{0.2}Co_{0.2}) O₂, Li (Ni_{0.7}Mn_{0.15}Co_{0.15}) O₂, Li (Ni_{0.8}Mn_{0.1}Co_{0.1}) O₂, Li (Ni_{0.9}Mn_{0.05}Co_{0.05}) O₂, LiNi_{0.6}Co_{0.2}0Al_{0.2}O₂, LiNi_{0.7}Co_{0.2}0Al_{0.1}O₂, LiNi_{0.8}Co_{0.15}Al_{0.05}O₂, LiNi_{0.85}Co_{0.1}Al_{0.05}O₂, LiNi_{0.88}Co_{0.1}Al_{0.02}O₂, LiMn₂O₄, and LiFePO₄ may be applied.

The electrolyte may be a liquid electrolyte or a solid electrolyte.

When the electrolyte is a liquid electrolyte, the electrolyte may include a lithium salt and a non-aqueous organic solvent.

The lithium salt may be applied without limitation as long as the lithium salt is commonly used for the electrolyte of lithium secondary batteries. For example, the lithium salt may include at least one compound selected from the group consisting of LiPF₆, LiBF₄, LiSbF₆, LiAsF₆, LiN (C₂F₅SO₂) 2, LiN (CF₃SO₂)₂, CF₃SO₃Li, LiC (CF₃SO₂)₃, LiC₄BO₈, LiTFSI, LiFSI, and LiClO₄.

The non-aqueous organic solvent may include a type of organic solvent that may be usable as a non-aqueous electrolyte in manufacturing typical lithium secondary batteries. In this case, the non-aqueous organic solvent may be included in an amount that is appropriately regulated in a generally acceptable range.

Specifically, the non-aqueous organic solvent may include typical organic solvents that may be usable as non-aqueous organic solvents for lithium secondary batteries, such as cyclic carbonate solvents, linear carbonate solvents, ester solvents, or ketone solvents, and these solvents may be used either singly or in combination of two or more.

The cyclic carbonate solvent may include at least one selected from the group consisting of ethylene carbonate (EC), vinylene carbonate (VC), fluoroethylene carbonate (FEC), propylene carbonate (PC), and butylene carbonate (BC).

The linear carbonate solvent may include at least one selected from the group consisting of dimethyl carbonate (DMC), diethyl carbonate (DEC), dipropyl carbonate (DPC), ethylmethyl carbonate (EMC), methylpropyl carbonate (MPC), and ethylpropyl carbonate (EPC).

The ester solvent may include at least one selected from the group consisting of methyl acetate, ethyl acetate, propyl acetate, methyl propionate, ethyl propionate, γ-butyrolactone, γ-valerolactone, γ-caprolactone, δ-valerolactone, and ε-caprolactone.

Polymethylvinyl ketone and the like may be used as the ketone solvent.

When the electrolyte is a liquid electrolyte, the lithium secondary battery may further include a separator.

As the separator, a typically used porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, may be used alone or in a lamination therewith, or a typical porous nonwoven fabric, for example, a nonwoven fabric formed of high melting point glass fibers or polyethylene terephthalate fibers may be used, but the separator is not limited thereto. Furthermore, a coated separator including a ceramic component or a polymer component may be used to secure heat resistance or mechanical strength, and the separator having a single-layer structure or a multi-layer structure may be used.

In this case, the porous separator may generally have a pore diameter of 0.01 to 50 μm, and have a porosity of 5 to 95%. In addition, the porous separator may generally have a thickness of 5 to 300 μm.

Meanwhile, when the electrolyte is a solid electrolyte, the electrolyte may be a polymer-based solid electrolyte, an oxide-based solid electrolyte, a sulfide-based solid electrolyte, or a mixture thereof.

The polymer solid electrolyte may include, for example, a polyether-based polymer, a polycarbonate-based polymer, an acrylate-based polymer, a polysiloxane-based polymer, a phosphazene-based polymer, a polyethylene derivative, an alkylene oxide derivative such as polyethylene oxide, a phosphoric acid ester polymer, poly agitation lysine, polyester sulfide, polyvinyl alcohol, polyvinylidene fluoride and a derivative thereof, a polymer containing an ionic dissociation group. In addition, the polymer electrolyte is a polymer resin, and may be, for example, a branched copolymer in which an amorphous polymer such as PMMA, polycarbonate, polysiloxane, and/or phosphazene is copolymerized with a PEO (poly ethylene oxide) main chain as a comonomer, a comb-like polymer resin, and a cross-linked polymer resin, and at least one type therefrom may be included.

The oxide-based solid electrolyte may be, for example, an LLZO-based compound, an LLTO-based compound such as Li₃ₓLa_{2/3-x}TiO₃, a LISICON-based compound such as Li₁₄Zn (GeO₄)₄, an LATP-based compound such as Li_{1.3}AlO_{0.3}Ti_{1.7} (PO₄)₃, an LAGP-based compound such as (Li₁₊ₓGe₂₋ₓAlₓ (PO₄)₃), and a LIPON-based compound, but is not particularly limited thereto.

The sulfide-based solid electrolyte may include at least any one of Li₆PS₅Cl, Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂SLi₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, or Li₂S—GeS₂—ZnS, but is not particularly limited thereto.

### Method for Manufacturing Self-Standing Film for Anode of Lithium Secondary Battery

Hereinafter, a method for manufacturing a self-standing film for an anode of a lithium secondary battery of the present disclosure will be described, and overlapping descriptions will not be given for the self-standing film for an anode of a lithium secondary battery and components included therein.

A method for manufacturing a self-standing film for an anode of a lithium secondary battery includes forming an anode active material layer through a film fabrication process using a composition for forming an anode of a lithium secondary battery, the composition including the anode active material, the conductive material, the first binder, and the second binder.

The first binder in the composition for forming an anode of a lithium secondary battery may include particles of the triblock copolymer, which have an average diameter (D50) of 1 μm to 50 μm. The average diameter (D50) indicates a diameter corresponding to 50% of the volume cumulative distribution measured using a laser diffraction/scattering particle size distribution measurement instrument.

The first binder in the composition for forming an anode of a lithium secondary battery is substantially spherical, and may be true spherical or almost true spherical, and may specifically have an average sphericity of 0.7 to 1.0, preferably 0.8 to 1.0, and more preferably 0.9 to 1.0. That is, before manufacturing the self-standing film for an anode of a lithium secondary battery, the particles of the first binder in the composition for forming an anode of a lithium secondary battery including the first binder may be dispersed in the composition for forming an anode of a lithium secondary battery including the first binder while substantially maintaining the spherical form.

In this case, the sphericity of the first binder in the composition for forming an anode of a lithium secondary battery is a value obtained by measuring major and minor diameters of 10 randomly selected particles using images of binder particles observed through a scanning electron microscope (SEM), calculating the ratio of the minor diameter/major diameter of each particle, and determining the average value of the ratio of the minor diameter/major diameter, and the closer the sphericity is to 1, the more sphere-like the particle.

Meanwhile, the second binder in the composition for forming an anode of a lithium secondary battery may include particles of the fluorine-based resin, which have an average diameter (D50) of 10 nm to 1000 nm. In this case, the average diameter (D50) indicates a diameter corresponding to 50% of the volume cumulative distribution measured using a laser diffraction/scattering particle size distribution measurement instrument.

The second binder in the composition for forming an anode of a lithium secondary battery may not have a definite form. For example, the second binder in the composition for forming an anode may remain in the spherical form with a relatively low average sphericity and be dispersed in the composition for forming an anode of a lithium secondary battery including the second binder, or may be present on a surface of the anode active material and/or the conductive material in the composition for forming an anode of a lithium secondary battery.

In an embodiment, the film fabrication process of the self-standing film for an anode of a lithium secondary battery may be performed through calendering (rolling). That is, the composition for forming an anode of a lithium secondary battery including the anode active material, the conductive material, the first binder, and the second binder may be subjected to passing between a pair of rolls, and pressed and rolled to form the self-standing film for an anode of a lithium secondary battery.

In this case, at the beginning of the film fabrication process, contact takes place between the first binder containing the substantially spherical triblock copolymer and the anode active material or the conductive material by a high external force (shear force, tension force, and the like), and then as the external force decreases in the back-end of the film fabrication process, the distance between the anode active materials or the conductive materials increases, and thus the first binder containing the triblock copolymer in contact with a surface of the anode active material or the conductive material may flexibly be deformed while maintaining the bond to have a non-continuous columnar or wire-like linear form.

Meanwhile, the second binder containing the fluorine-based resin having no definite form may be fiberized by high external force (shear force, tension force, and the like) applied at the beginning of the film fabrication process. The second binder fiberized by external force may remain in the fibrous form, and the anode active material and/or the conductive material may be effectively fixed by being wound and bound by the fibrous fluorine-based resin.

In an embodiment, the film fabrication of the self-standing film for an anode of a lithium secondary battery may be performed at a temperature equal to or higher than the first glass transition temperature and the second glass transition temperature each corresponding to the first hard block and the second hard block. The first hard block and the second hard block form a crosslink (connection) through a physical bond having relatively low bonding energy, and thus may remain in the same form and size below the glass transition temperature, but may be easily molded above the glass transition temperature. Accordingly, when the film fabrication process of the self-standing film for an anode of a lithium secondary battery is performed at a temperature equal to or higher than the first glass transition temperature and the second glass transition temperature, each hard block included in the triblock copolymer is flexibly deformed while maintaining a bond with the anode active material or the conductive material, and thus the first binder portion may provide a physical crosslinking point (connection point) having a linear (non-continuous columnar or wire-like) form to form a solid three-dimensional network structure around the point.

In addition, the film fabrication of the self-standing film for an anode of a lithium secondary battery may be performed at a temperature equal to or higher than the glass transition temperature of the fluorine-based resin. In this case, when the film fabrication of the self-standing film for an anode is performed at the temperature described above, sufficient flexibility of the second binder may be additionally obtained, and accordingly, the bond between the second binder and the anode active material and/or the second conductive material is effectively maintained and also the second binder may be flexibly deformed to facilitate molding of the self-standing film for an anode of a lithium secondary battery.

In an embodiment, in the composition for forming an anode of a lithium secondary battery, the first binder and the second binder may be at a mass ratio of 1:3 to 0.3, 1:3 to 0.6, 1:3 to 0.75, 1:3 to 0.9, 1:2.5 to 0.9, 1:2 to 0.9, 1:1.75 to 0.9, 1:1.5 to 0.9, or 1:1.3 to 0.9. In this case, when the mass ratio of the first binder and the second binder satisfies the numerical ranges described above, the self-standing film for an anode of a lithium secondary battery formed from the composition for forming an anode of a lithium secondary battery may have excellent mechanical properties and excellent flexibility, and may also have excellent adhesion to a current collector and low sheet resistance.

In an embodiment, the film fabrication process may be performed using a dry method. That is, the composition for forming an anode of a lithium secondary battery may substantially include no solvent. When the film fabrication process is performed using a wet method, there is a limit to increasing a loading amount of an electrode due to a liquid slurry, and a network structure between the binder and the active material/conductive material may not be formed in some cases, but as the film fabrication process according to the present disclosure is performed using a dry method, a high electrode loading amount that allows high energy density is achievable and a network structure between the binder and the active material may be formed more effectively.

### Method for Manufacturing Anode for Lithium Secondary Battery

Hereinafter, a method for manufacturing an anode for a lithium secondary battery of the present disclosure will be described, and overlapping descriptions will not be given for the anode for a lithium secondary battery and components included therein.

The method for manufacturing an anode for a lithium secondary battery may include the method for manufacturing a self-standing film for an anode of a lithium secondary battery described above, and disposing a current collector on the self-standing film for an anode of a lithium secondary battery.

In an embodiment, the current collector may be disposed through calendering (rolling). That is, the current collector and the self-standing film for an anode of a lithium secondary battery may be subjected to passing between a pair of rolls, and pressed and rolled to form the anode for a lithium secondary battery.

In an embodiment, the disposing of the current collector (e.g., the calendering) may be performed at 80 to 200° C., 90 to 170° C., or 95 to 145° C., and preferably may be performed at a temperature that is equal to or higher than the first glass transition temperature and the second glass transition temperature each corresponding to the first hard block and the second hard block, and that is equal to or higher than the glass transition temperature of the fluorine-based resin. In this case, when the disposing of the current collector is performed in the temperature ranges described above, the adhesion between the self-standing film and the current collector may be improved.

Hereinafter, the present disclosure will be described in more detail through Examples. However, these Examples are provided to assist understanding of the present disclosure, and the scope of the present disclosure is not limited to the Examples in any sense.

### Example 1: Manufacture of Self-Standing Film for Anode of Lithium Secondary Battery Containing First Binder and Second Binder

Graphite as an anode active material, carbon black as a conductive material, powder-type SBS triblock copolymer as a first binder (glass transition temperature of polystyrene block: 100° C., glass transition temperature of polybutadiene block: −100° C.), and PTFE as a secondary binder were mixed without a solvent at a mass ratio of 96:1:1:2.

The mixed powder was roll-pressed into a self-standing film, using a 2-roll press heated to 100° C.

### Examples 2 and 3: Manufacture of Self-Standing Film for Anode of Lithium Secondary Battery Containing First Binder and Second Binder

A self-standing film was formed in the same manner as in Example 1, except that the mass ratio of the anode active material (graphite), the conductive material (carbon black), the first binder (SBS triblock copolymer), and the second binder (PTFE) was changed as shown in Table 1 below.

### Comparative Example 1: Manufacture of Self-Standing Film for Anode of Lithium Secondary Battery Containing Second Binder

The anode active material (graphite), the conductive material (carbon black), and the second binder (PTFE) were mixed without solvent at a mass ratio of 96:1:3.

The mixed powder was roll-pressed into a self-standing film, using a 2-roll press heated to 100° C.

### Reference Example 1: Manufacture of Self-Standing Film for Anode of Lithium Secondary Battery Containing First Binder

The anode active material (graphite), the conductive material (carbon black), and the first binder (SBS triblock copolymer) were mixed without solvent at a mass ratio of 96:1:3.

The mixed powder was roll-pressed into a self-standing film, using a 2-roll press heated to 100° C.

TABLE 1

| | 1st | 2nd | Anode active | Conducting |
|---|---|---|---|---|
| | binder | binder | material | material |
| | [Mass % ] | [Mass %] | [Mass %] | [Mass %] |
| Example 1 | 1 | 2 | 1 | 96 |
| Example 2 | 1.5 | 1.5 | 1 | 96 |
| Example 3 | 2 | 1 | 1 | 96 |
| Comparative | 0 | 3 | 1 | 96 |
| Example 1 | | | | |
| Reference | 3 | 0 | 1 | 96 |
| Example 1 | | | | |

### Experimental Example 1: SEM Image Observation of Mixed Powder in Example 2 and Self-Standing Film Prepared Therefrom

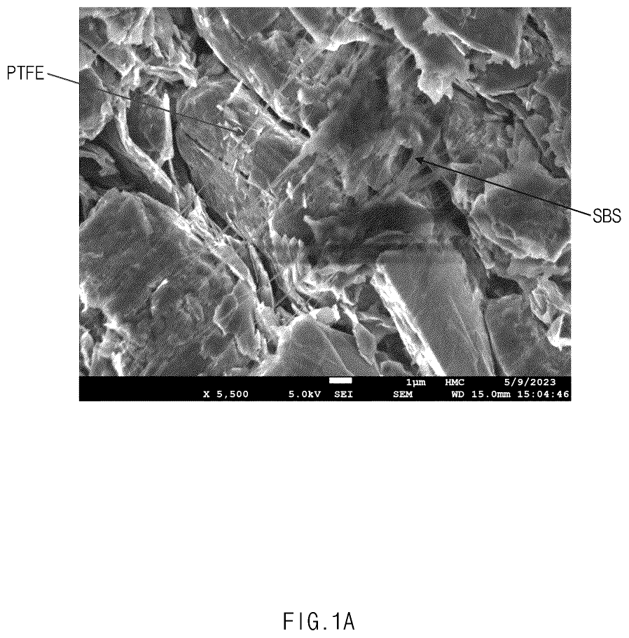

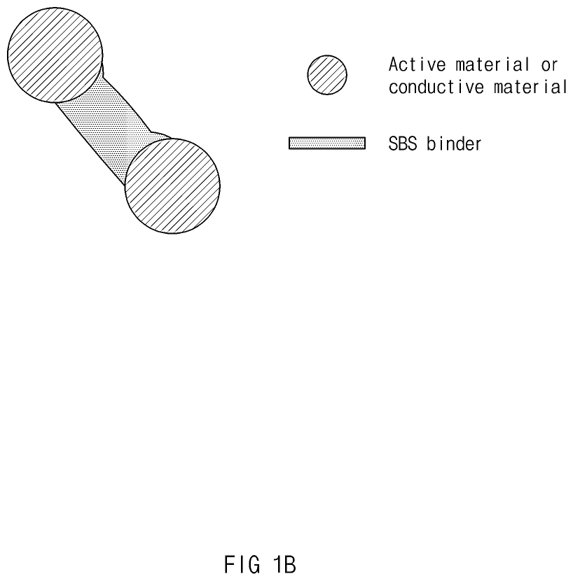

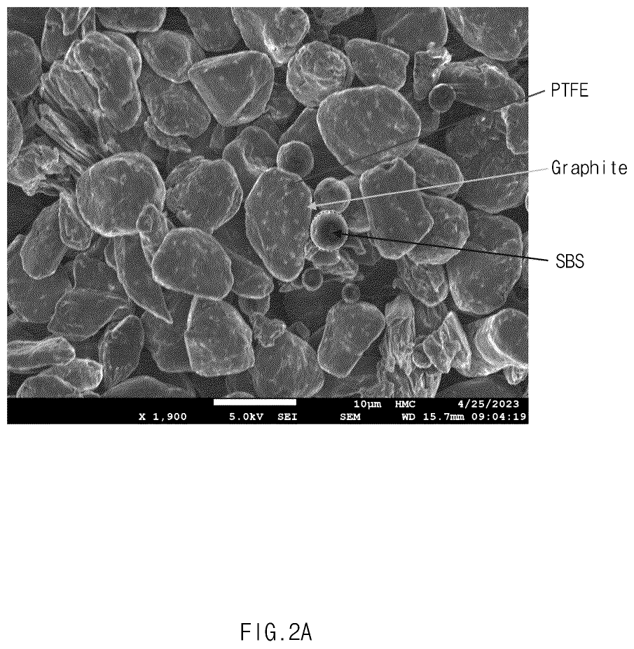

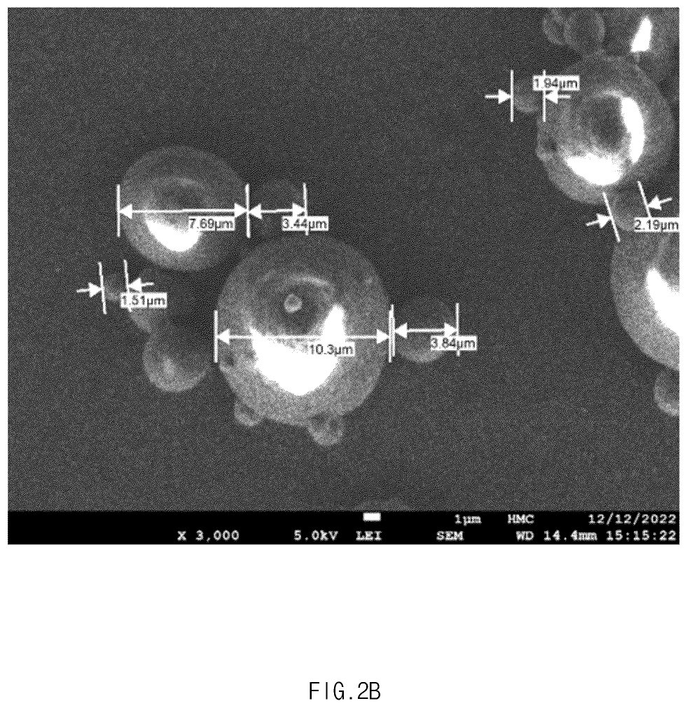

An SEM image was taken for the self-standing film for an anode of Example 2 and is shown in FIG. 1A, and before manufacturing the self-standing film for an anode of Example 2, SEM images were taken for mixed powder of an anode active material (graphite), a conductive material (carbon black), a first binder (SBS triblock copolymer), and a second binder (PTFE) and are shown in FIG. 2A, and in this case, the SEM image taken only for the SBS powder is shown in FIG. 2B.

Referring to FIG. 1A, it is seen that after the film fabrication process, the columnar SBS binder forms a network structure connecting between anode active materials, between conductive materials, or between anode active materials and conductive materials, and is in the form of a column having an average width perpendicular to a longitudinal direction of about 0.4 to 0.5 μm.

In addition, it is seen that after the film fabrication process, PTFE has a fibrous form and is bound by winding the anode active material and/or conductive material, and portions of the anode active material and/or the conductive material bonded and fixed by PTFE are connected by the columnar SBS binder.

In addition, it is seen that PTFE has a greater average length and a smaller average width perpendicular to the longitudinal direction than the SBS binder.

FIG. 1B schematically shows a columnar SBS binder connecting between any one of the anode active material or the conductive material and another one of the anode active material or the conductive material in the network structure of the self-standing film for an anode manufactured according to Example 2. In this case, it is seen that the SBS binder in the form of a non-continuous column makes point contact with an outer surface of each of an active material domain or a conductive material domain, creating a structure connecting the domains.

Referring to FIG. 2A, it is seen that SBS is dispersed in the mixed powder while maintaining an almost spherical form (average diameter (D50): 8 D₅₀, average sphericity: 0.95), and PTFE is mostly present on the surface of the anode active material. In addition, as shown in FIG. 2B, it is seen that the SBS powder before the manufacturing of the mixed powder described above is also almost spherical.

### Experimental Example 2: Evaluation of Tensile Strength

To evaluate the tensile strength of the self-standing films of Examples 1 to 3, Comparative Example 1, and Reference Example 1, each self-standing film was punched to have a width of 2 cm and a height of 6 cm to prepare samples, and the samples were measured while being pulled at a rate of 5 mm/min using UTM equipment to obtain a strain-length dependence graph of stress, and based on the graph, the tensile strength was measured and the results are shown in Table 2 below.

### Experimental Example 3: Evaluation of Adhesion to Current Collector

A current collector (copper foil having a thickness of 8 μm from Nexilis) coated with a primer layer (Ketjen Black) and the self-standing films of Examples 1 to 3, Comparative Example 1, and Reference Example 1 were rolled using a 2-roll press heated to 100° C. to manufacture an anode for a lithium secondary battery.

Thereafter, a peeling test was performed on the current collector and the self-standing films according to the standards of ASTM D1876, and the results are shown in Table 1 below.

### Experimental Example 4: Evaluation of Sheet Resistance

To evaluate the sheet resistance of the self-standing films of Examples 1 to 3, Comparative Example 1, and Reference Example 1, each self-standing film was punched to have a width of 2 cm and a height of 6 cm, and then the sheet resistance was measured using a sheet resistance meter from HIOKI (measurement conditions: 50 mA, 10 A), and the results are shown in Table 2 below.

TABLE 2

| | Tensile | | Sheet |
|---|---|---|---|
| | strength | Adhesion | resistance |
| | [MPa] | [gf/mm] | [mΩ/sq] |
| Example 1 | 0.26 | 0.52 | 3.71 |
| Example 2 | 0.26 | 0.77 | 3.34 |
| Example 3 | 0.29 | 0.30 | 5.00 |
| Comparative | 0.14 | 0.70 | 8.75 |
| Example 1 | | | |
| Reference | 0.69 | 1.00 | 2.38 |
| Example 1 | | | |

Referring to Table 2, the self-standing films of Examples 1 to 3 were observed to have excellent tensile strength and thus have excellent mechanical properties compared to the self-standing film of Comparative Example 1.

Meanwhile, the self-standing films of Examples 1 to 3 were observed to have relatively low sheet resistance compared to the self-standing film of Comparative Example 1, and also the self-standing film of Example 2 was observed to have excellent adhesion compared to the self-standing film of Comparative Example 1.

### Experimental Example 5: Evaluation of Flexibility

To evaluate the flexibility of the self-standing films of Example 2, Comparative Example 1, and Reference Example 1, a cylindrical bar having an average diameter of 10 mm was wrapped with the self-standing films of Example 2, Comparative Example 1, and Reference Example 1, and then the occurrence of cracks was evaluated with the naked eye, and the results are shown in Table 3 below.

TABLE 3

| | Flexibility |
|---|---|
| Example 2 | Good |
| Comparative | Good |
| Example 1 | |
| Reference | Poor |
| Example 1 | |

Referring to Table 3, it was confirmed that the self-standing films of Example 2 and Comparative Example 1 had greater flexibility than the self-standing film of Reference Example 1.

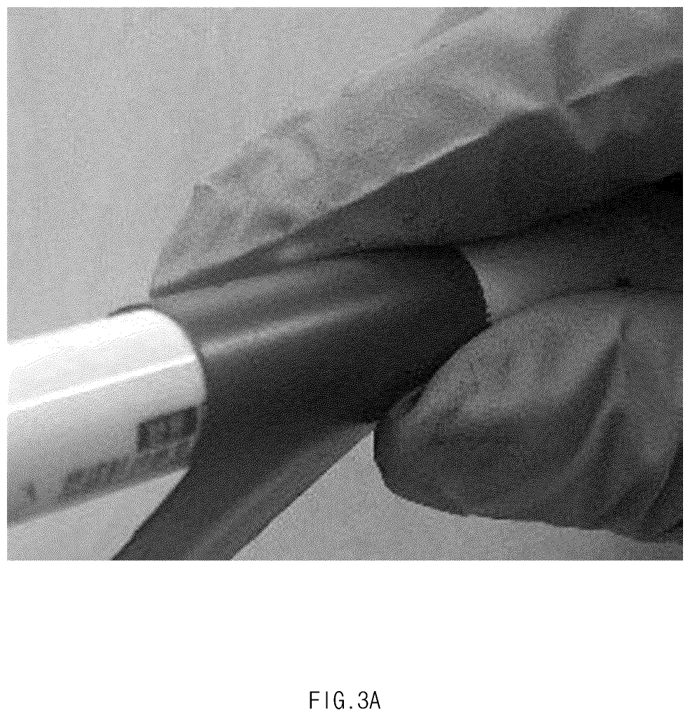

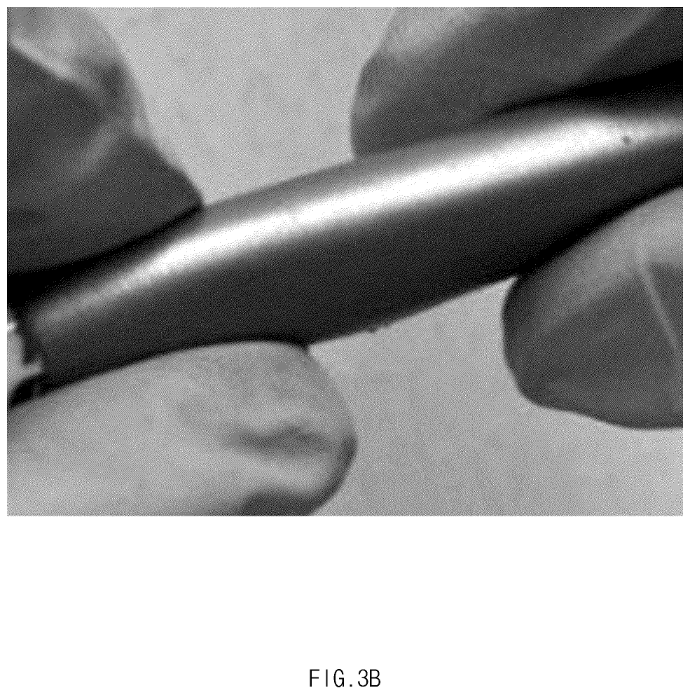

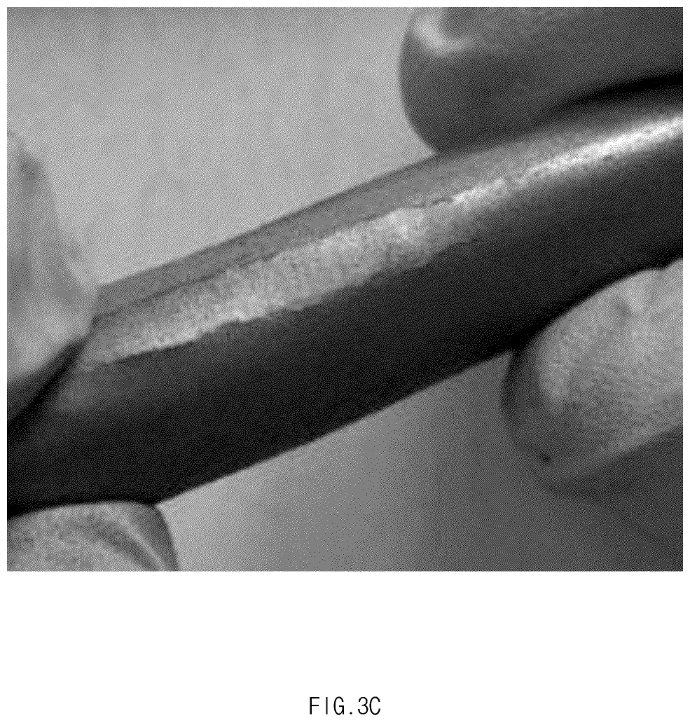

Specifically, referring to FIG. 3A, when a cylindrical bar was wrapped with the self-standing film of Example 2, no cracks were observed in the self-standing film of Example 2. In addition, referring to FIG. 3B, even when a cylindrical bar was wrapped with the self-standing film of Comparative Example 1, no cracks were observed in the self-standing film of Comparative Example 1. In contrast, referring to FIG. 3C, when a cylindrical bar was wrapped with the self-standing film of Reference Example 1, cracks were observed in the self-standing film of Reference Example 1 due to lack of flexibility.

### Experimental Example 6: Evaluation of Tensile Strength According to Width of Fabricated Film

The tensile strength of the self-standing films of Example 2, Comparative Example 1, and Reference Example 1 was measured when the width of fabricated films was set to 100 mm, 200 mm, and 300 mm, and the results are shown in Table 4 below.

In this case, the tensile stress measured in Experimental Example 2 was multiplied by the cross-sectional area of each self-standing film having a different width of fabricated films to measure the tensile strength.

TABLE 4

| Width of | Tensile strength [N] | | |
|---|---|---|---|
| fabricated | Example | Comparative | Reference |
| film [mm] | 2 | Example 1 | Example 1 |
| 100 | 5.5 | 1.65 | 16.1 |
| 200 | 11.1 | 3.3 | 32.2 |
| 300 | 16 | 4.95 | 48.3 |

Referring to Table 4, the self-standing film of Example 2, like the self-standing film of Reference Example 1, showed excellent overall tensile strength regardless of the film fabrication width values of 100 mm, 200 mm, and 300 mm.

In contrast, the self-standing film of Comparative Example 1 showed inferior tensile strength at all film fabrication widths of 100 mm, 200 mm, and 300 mm, and this was less than the minimum tensile strength of 5 N for application to commonly used roll press equipment.

Referring to the descriptions above, the self-standing films of Examples 1 to 3 containing a blend of the first binder and the second binder had greater tensile strength than the self-standing film of Comparative Example 3 containing only the second binder, and showed excellent overall tensile strength regardless of the film fabrication width of 100 mm, 200 mm, and 300 mm, and thus were determined to have excellent mechanical properties and have greater flexibility than the self-standing film of Comparative Example 3.

Accordingly, it is seen that the self-standing films of Examples 1 to 3 having excellent mechanical properties and excellent flexibility are suitable for mass production using roll press equipment and the like, compared to the self-standing film of Comparative Example 3.

Meanwhile, the self-standing films of Examples 1 to 3 were observed to have a relatively low sheet resistance compared to the self-standing film of Comparative Example 3, and in particular, the self-standing films of Examples 1 and 2 were observed to have a very low sheet resistance. In addition, the self-standing film of Example 2 was observed to have excellent adhesion compared to the self-standing film of Comparative Example 3.

Accordingly, it is seen that among the self-standing films of Examples 1 to 3 having excellent mechanical properties and excellent flexibility, the self-standing film of Example 2 is superior in terms of sheet resistance and adhesion properties.

A self-standing film for an anode of a lithium secondary battery of the present disclosure may have excellent mechanical properties derived from a triblock copolymer included in a first binder and have excellent flexibility derived from a fluorine-based resin included in a second binder, and accordingly, mass production using roll press equipment and the like may be achievable.

While the present disclosure has been shown and described in connection with the exemplary embodiments, it will be apparent to those skilled in the art that modifications and variations can be made without departing from the spirit and scope of the invention as defined by the appended claims.

What is claimed is:

1. A self-standing film suitable for an anode of a lithium secondary battery, the self-standing film comprising:
an anode active material; a conductive material; a first binder comprising a triblock copolymer; and a second binder comprising a fluorine-based resin,
wherein the triblock copolymer comprises a soft block derived from aliphatic or cycloaliphatic diene-based monomers and exhibiting a rubber phase at room temperature, and a first hard block and a second hard block each connected to ends of the soft block, derived from an aromatic ring-containing ethylenically unsaturated monomer, and exhibiting a glass phase at room temperature, and
the first binder is in the form of a non-continuous column connecting between any one of a) a domain of the anode active material or b) a domain of the conductive material and i) another one of a domain of the anode active material or ii) a domain of the conductive material.

2. The self-standing film of claim 1, wherein the domain of the anode active material or the domain of the conductive material and the first binder which is in the form of a non-continuous column are connected to form a three-dimensional network structure.

3. The self-standing film of claim 1, wherein the second binder is in a fibrous form that binds the anode active material and the conductive material.

4. The self-standing film of claim 1, wherein the anode active material and the conductive material bounded by the second binder are connected by the first binder in the form of a column.

5. The self-standing film of claim 1, wherein the first binder and the second binder are at a mass ratio of 1:3 to 0.3.

6. The self-standing film of claim 1, wherein the first binder has an average width perpendicular to a longitudinal direction of 0.1 μm to 2 μm.

7. The self-standing film of claim 1, wherein a first glass transition temperature and a second glass transition temperature each corresponding to the first hard block and the second hard block are independently 50° C. to 120° C., and
a third glass transition temperature corresponding to the soft block is −120° C. to −50° C.

8. The self-standing film of claim 1, wherein the soft block is derived from an aliphatic diene-based monomer comprising at least one selected from the group consisting of a butadiene-based monomer, a pentadiene-based monomer, and a hexadiene-based monomer.

9. The self-standing film of claim 1, wherein the first hard block and the second hard block are each independently derived from an aromatic ring-containing ethylenically unsaturated monomer comprising at least one of a styrene-based monomer and an aromatic (meth)acryl-based monomer.

10. The self-standing film of claim 1, wherein the fluorine-based resin comprises at least one selected from the group consisting of polyvinylidene fluoride (PVDF), polyvinylidene fluoride-hexafluoropropylene (PVDF-HFP), polyvinylidene fluoride-trifluoroethylene (PVDF-TrFE), polyvinylidene fluoride-tetrafluoroethylene (PVDF-TFE), polyvinylidene fluoride-chlorofluoroethylene (PVDF-CTFE), and polytetrafluoroethylene (PTFE).

11. An anode for a lithium secondary battery, the anode comprising:
a current collector; and
the self-standing film for an anode of a lithium secondary battery according to claim 1.

12. The anode for a lithium secondary battery of claim 11, wherein the current collector further comprises a primer layer containing a carbon-based material on a surface of a side where the self-standing film for an anode of a lithium secondary battery is disposed.

13. A lithium secondary battery comprising:
the anode for a lithium secondary battery of claim 11;
a cathode for a lithium secondary battery; and
an electrolyte.

14. A method for manufacturing a self-standing film suitable for an anode of a lithium secondary battery, the method comprising:
forming an anode active material layer through a film fabrication process using a composition for forming an anode of a lithium secondary battery, the composition comprising:
an anode active material; a conductive material; a first binder comprising a triblock copolymer of which copolymer particles having an average diameter (D₅₀) of 1 μm to 50 μm; and a second binder comprising a fluorine-based resin,
wherein the triblock copolymer comprises a soft block derived from aliphatic or cycloaliphatic diene-based monomers and exhibiting a rubber phase at room temperature, and a first hard block and a second hard block each connected to both ends of the soft block, derived from an aromatic ring-containing ethylenically unsaturated monomer, and exhibiting a glass phase at room temperature.

15. The method of claim 14, wherein the first binder and the second binder are at a mass ratio of 1:3 to 0.3.

16. The method of claim 14, wherein the first binder comprises spherical particles having an average sphericity of 0.8 to 1.0.

17. The method of claim 14, wherein the film fabrication process is performed using a dry method.

18. The method of claim 14, wherein the film fabrication process is performed at a temperature equal to or higher than the first glass transition temperature and the second glass transition temperature each corresponding to the first hard block and the second hard block.

19. A method for manufacturing an anode for a lithium secondary battery, the method comprising:
a) forming an anode active material layer of claim 14; and
b) disposing a current collector on the formed anode active material layer.

20. A vehicle comprising the battery of claim 13.
